(19) United States
(12) Patent Application Publication
(10) Pub. No.: US 2005/0001816 A1
(43) Pub. Date: Jan. 6, 2005

(54) Self-adhesive applique for a computer pointing device

(76) Inventors: Trevor Clark Thompson, Mountain View, CA (US); Benjamin Thomas Coles, Seal Beach, CA (US)

Correspondence Address: BURNS DOANE SWECKER & MATHIS L L P, POST OFFICE BOX 1404, ALEXANDRIA, VA, 22313-1404, US

(21) Appl. No.: 10/808,775

(22) Filed: Mar. 24, 2004

Related U.S. Application Data
(60) Provisional application No. 60/456,981, filed on Mar. 24, 2003.

(51) Int. Cl. G09G 5/08

(52) U.S. Cl. 345/163; 345/184

(57) ABSTRACT

The present invention discloses a self-adhesive, conformable appliqué for a computer pointing device or computer mouse. The appliqués are designed to conform to the surface of the computer mouse to cover areas of hand to mouse contact, providing an improved gripping surface to the mouse, enhanced comfort for the user, and a reduction dirt, lint, sweat, and oils from contacting the computer mouse.

### REFERENCES TO PRIOR APPLICATIONS

The present application is related to co-pending U.S. Provisional Patent Application, Ser. No. 60/456,981, filed Mar. 24, 2003, and claims the benefit thereof.

### BACKGROUND OF THE INVENTION

1. Field of the Invention

The present invention relates to the general field of computer pointing devices, and more particularly, to adhesive appliqués applied to their external surface.

2. Description of the Related Art

Computer pointing devices, otherwise known as a computer mouse, are utilized by large numbers of people everyday. Due to the extended period of time people spend using their computers, the comfort of the pointing device or mouse is important. The current art computer mouse is generally constructed of a hard outer plastic shell, that can be uncomfortable to hold for long periods of time, and get slippery due to the build-up of soils and sweat from the user's hand. What is needed is a computer pointing device that has improved gripping surfaces more resistant to the build up of dirt and soils, and is more comfortable for the user.

### SUMMARY OF THE INVENTION

It is an object of the present invention to provide a computer pointing device including an outer surface having a first portion and a second portion, the first portion operative to support a user's palm when the computer pointing device is placed within said user's hand, and the second portion having at least one movable panel, placed within reach of at least one user's finger, operative to transmit a selection command from the computer pointing device to a computer by deflection of the movable panel by the user's finger. A first appliqué is attached to the first portion of the outer surface and a second appliqué is attached to the movable panel.

### BRIEF DESCRIPTION OF THE DRAWINGS

FIG. 1 is a cross-section view of an appliqué according to an embodiment of the present invention;

FIG. 2 is a top view of an appliqué according to an embodiment of the present invention;

FIG. 3 is a perspective view of a computer pointing device with affixed appliqués according to an embodiment of the present invention; and,

FIG. 4 is a top view of a computer pointing device with affixed appliqués according to an embodiment of the present invention.

### DETAILED DESCRIPTION OF THE PREFERRED EMBODIMENTS

The present invention is a self-adhesive, conformable appliqué for a computer pointing device or computer mouse. The appliqués are designed to conform to the surface of the computer mouse to cover areas of hand to mouse contact. It is an object of the present invention to provide an improved gripping surface to the mouse. It is an object of the present invention to provide enhanced comfort to the user of the computer mouse. It is an object of the present invention to reduce dirt, lint, sweat, and oils from contacting the computer mouse.

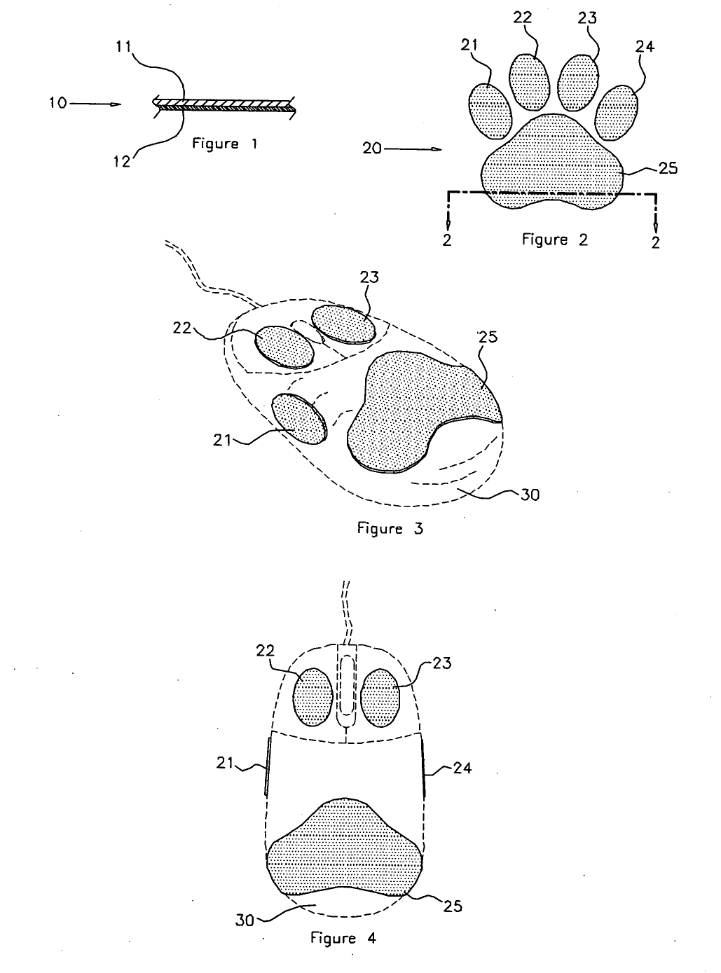

FIG. 1 is a cross-section view of an appliqué 10 according to an embodiment of the present invention. Appliqué 10 is formed by joining a textured top surface 11 and an adhesive backing 12. The textured top surface 11 is constructed from light weight, conformable, absorbent, and/or resilient material to provide a comfortable gripping surface far the computer mouse. The textured top surface 11 may be made from a variety of materials including, but not limited to, fabrics such as flannel, velvet, leather, or fleece; pliable gel; foam; plastic; or rubber. The bottom surface of the appliqué is comprised of adhesive backing 12 that is used to attach the appliqué 10 to the exterior surface of the computer mouse. The adhesive permits the appliqué to be easily applied, removed, and repositioned at the discretion of the user. The appliqués are constructed of flexible material so that they conform to curved surfaces when applied thereto. The appliqués may be produced in a wide variety of colors and patterns, which allows the user to customize their computer mouse. Additionally, the appliqués can be produced with advertising logos or badges.

The present invention may be practiced over a wide range of appliqué shapes. The following figures illustrate the preferred embodiment of the present invention. It is to be understood that, rather than presenting an exhaustive list of possible embodiments of the present invention, the following figures present one example to demonstrate a possible appliqué shape that may be employed.

FIG. 2 is a top view of an appliqué 20 according to an embodiment of the present invention. The cross sectional view through 2-2 has been previously shown in FIG. 1. Appliqué 20 is comprised of five individual appliqués 21, 22, 23, 24, and 25. The exemplary appliqué 20 is in the shape of a paw print.

FIG. 3 is a perspective view of a computer pointing device 30 with affixed appliqués 21-25 according to an embodiment of the present invention. Appliqués 21, 22, 23, and 25 are affixed to the surface of the computer mouse 30. Appliqué 21 is affixed to the left side of the mouse in the position where the thumb of aright handed user rests. Appliqué 22 is affixed to the left mouse button in the position where the index finger of aright handed user rests. Appliqué 23 is affixed to the right mouse button in the position where the middle finger of a right handed user rests. Appliqué 25 is affixed to the top rear portion of the computer mouse in the position where the palm of the user rests. Appliqués may be positioned by the user in positions most comfortable to the natural grip of the user.

FIG. 4 is a top view of a computer pointing device with affixed appliqués according to an embodiment of the present invention.

1. A computer pointing device comprising:
an outer surface having a first portion and a second portion,
said first portion operative to support a user's palm when said computer pointing device is placed within said user's hand,
said second portion having at least one movable panel, placed within reach of at least one user's finger, operative to transmit a selection command from said computer pointing device to a computer by deflection of said at least one movable panel by said at least one user's finger;
a first appliqué attached to said first portion of said outer surface; and
a second appliqué attached to said at least one movable panel.

2. A computer pointing device as recited in claim 1, wherein said first appliqué and said second appliqué are attached by means of an adhesive.

3. A computer pointing device as recited in claim 1, wherein said first appliqué and said second appliqué are flexible and conform to a non-planar surface.

4. A computer pointing device as recited in claim 1, wherein said first appliqué and said second appliqué have a textured top surface.

5. A computer pointing device as recited in claim 4, wherein said textured top surface is made from a fabric.

6. A computer pointing device as recited in claim 4, wherein said textured top surface is made from leather.

7. A computer pointing device as recited in claim 4, wherein said textured top surface is made from a pliable gel.

8. A computer pointing device as recited in claim 4, wherein said textured top surface is made from plastic or rubber.

9. A computer pointing device as recited in claim 8, wherein said textured top surface is made from a foam material.

10. A computer pointing device as recited in claim 1, wherein said first appliqué and said second appliqué have advertising printed thereon.
